(19) United States
(12) Patent Application Publication
(10) Pub. No.: US 2024/0352961 A1
(43) Pub. Date: Oct. 24, 2024

(54) Torque-Limiting Fastener

(71) Applicant: Axovia, L.L.C., Wharton, NJ (US)

(72) Inventor: Mark Nowakowski, Wharton, NJ (US)

(73) Assignee: Axovia, L.L.C., Wharton, NJ (US)

(21) Appl. No.: 18/138,404

(22) Filed: Apr. 24, 2023

(51) Int. Cl. F16B 31/02

(52) U.S. Cl. CPC F16B 31/021

(57) ABSTRACT

A torque-limiting fastener includes a head portion extending from a first end to a second end and including a first lumen extending longitudinally therethrough; a shaft portion extending from the second end of the head portion to a free end and including a second lumen in operative communication with the first lumen, the second lumen extending longitudinally through the shaft portion; and a plurality of perforations disposed at intervals around a periphery of at least one of the head portion and the shaft portion, the plurality of perforations being proximate a transition region in between the head portion and the shaft portion, wherein the transition region forms a frangible connection between the head portion and the shaft portion.

### FIELD

The present disclosure generally relates to a torque-limiting fastener for use in a variety of applications, such as for hermetically sealed pipes within processing systems. In some examples, the fastener may be a torque-limiting nut that secures to a fastener of a clamp to draw two pipes together and create a hermetic seal while preventing overtightening of the torque-limiting nut.

### BACKGROUND

Various industrial processes utilize piping systems to transport liquid or solid particles from one location to another. These processes are often employed in industries where sterility of equipment is paramount, such as in food and pharmaceutical processing. Certain manufacturing facilities attempt to maximize space-savings within buildings by running pipes along walls, ceilings, floors, and around various impediments to create efficient flow paths for particles flowing through the pipes. To facilitate the arrangement of pipes for such purpose, piping systems may be a collection of pipe segments that are joined together at joints. In some circumstances, gaskets may be used to form a joint between pipe segments. Each joint with a gasket between the pipe segments may then be sealed using a clamp.

To ensure a fastener properly secures the clamp, operators often use torque wrenches or other torque drivers. However, these tools have drawbacks. Due to the arrangement of the pipes within a facility, it may be difficult to place a torque wrench or other torque driver near a fastener. Additionally, due to the characteristics of such tools, clamps are often overtightened.

In certain industries such as the pharmaceutical or food processing industries, it is critical that piping systems within manufacturing facilities are hermetically sealed to prevent any contaminates from entering fluids within the pipes. In the event such seals are broken or otherwise comprised, biohazards may be created from the contamination that results. Moreover, overtightening of a joint may cause a gasket to expand into a channel of the pipe and may lead to particles of material being caught on the gasket, causing further risk of contamination. Existing systems also require periodic maintenance and sanitization and thus may need to be disassembled and sanitized to prevent material buildup or to prevent contaminants from entering the systems. To disassemble conventional systems, fasteners that secure the clamps to multiple pipes are loosened and removed. Each of the fasteners and clamps is then sanitized and reused. This method also has drawbacks. In large facilities with extensive piping systems, it may be difficult to remember which fasteners have been sanitized before being reinstalled. Additionally, repetitive tightening and loosening of fasteners may strip or otherwise damage threads and weaken the connection and the seal between adjacent pipes.

Accordingly, there is a need for fasteners designed to provide improved securement of pipe joints and securement of components in other similar applications.

### BRIEF SUMMARY

In accordance with an aspect of the present disclosure, a torque-limiting fastener includes: a head portion extending from a first end to a second end and including a first lumen extending longitudinally therethrough; a shaft portion extending from the second end of the head portion to a free end and including a second lumen in operative communication with the first lumen, the second lumen extending longitudinally through the shaft portion; and a plurality of perforations disposed at intervals around a periphery of at least one of the head portion and the shaft portion, the plurality of perforations being proximate a transition region in between the head portion and the shaft portion. In this arrangement, the transition region forms a frangible connection between the head portion and the shaft portion.

In another aspect, the second lumen is threaded and has a smaller diameter than the first lumen.

In a different aspect, the head portion further comprises a hexagonal outer surface.

In a further aspect, a thickness of the head portion varies along a length of each face of the hexagonal outer surface.

In another aspect, the plurality of perforations includes at least twelve perforations, each perforation of the plurality of perforations being disposed at approximately equal intervals around a periphery of at least one of the head portion and the shaft portion.

In yet another aspect, each perforation of the plurality of perforations extends into an elongate recess along a length of the head portion such that the plurality of perforations includes a plurality of elongate recesses, the plurality of elongate recesses defining respective valleys and peaks around a periphery of the first lumen.

In a different aspect, each perforation of the plurality of perforations includes a channel formed longitudinally through at least a portion of the head portion, the shaft portion, and the transition region.

In a further aspect, the channel is formed longitudinally through an entire length of the head portion from the first end to the second end.

In another aspect, the channel is formed longitudinally through less than the entire length of the head portion.

In a different aspect, the channel is formed longitudinally along less than half a length of the shaft portion from the second end to the free end.

In another aspect, each perforation of the plurality of perforations is defined in part by a recess in an outer surface of the shaft portion.

In a different aspect, the transition region defines a step between an outer diameter of the head portion and an outer diameter of the shaft portion, the outer diameter of the shaft portion being less than the outer diameter of the head portion.

In another aspect, the fastener is made of nylon.

In a further aspect, first lumen has a larger diameter than the second lumen. In some examples, the diameter of the first lumen is less than an outer diameter of the shaft portion.

In another aspect, the shaft portion includes two diametrically opposed flat faces formed at least partially through the outer surface outer sidewall of the shaft portion.

In accordance with another aspect, a fastener may include: a head portion with a first diameter; a shaft portion extending from the head portion, the shaft portion having a second diameter less than the first diameter; and a plurality of apertures, each aperture of the plurality of apertures extending from an outer surface of the fastener to a lumen of the fastener, the lumen extending through a longitudinal dimension of the fastener. In this arrangement, each aperture of the plurality of apertures includes a first surface region in the head portion and a second surface region in the shaft portion.

In another aspect, each aperture of the plurality of apertures has a first maximum cross-sectional dimension. For clarity, in this particular aspect, the maximum cross-sectional dimension of each aperture is approximately the same.

In a different aspect, the first maximum cross-sectional dimension is 10% or less of the second diameter.

In a further aspect, each aperture of the plurality of apertures is equally spaced around a perimeter of the lumen.

In another aspect, the plurality of apertures defines a shear plane extending through a transition region between the head portion and the shaft portion such that when a predetermined torque is applied to the fastener, the fastener breaks along the shear plane. The shear plane may be perpendicular to a central longitudinal axis of the fastener.

In a further aspect, the predetermined torque is in a range from approximately of 30 in-lbs to approximately 50 in-lbs.

In another aspect, the fastener further comprises a tether attached to the head portion and the shaft portion.

In accordance with another aspect, a method of securing a connection between pipe ends, the method may include the following steps: threading a nut onto a threaded rod of a clamp holding together two pipe ends with a gasket disposed between the pipe ends; and applying torque to a head portion of the nut so that a shaft portion of the nut presses against a body of the clamp, the torque being applied until the head portion shears off the shaft portion along a shear plane, the shearing of the head portion occurring when the applied torque reaches a predetermined torque. In this method, the nut includes a laterally facing outer surface and a longitudinally extending lumen, a portion of the laterally facing outer surface being in operative communication with the lumen to define the shear plane of the nut.

In a different aspect, the applying torque step further includes applying torque to the head portion such that the head portion shears along the shear plane defined by a plurality of perforations extending at least partially through at least one of the head portion of the nut and the shaft portion of the nut.

In a further aspect, the applying torque step further includes applying torque to the head portion such that the head portion shears along the shear plane at an interface between the head portion and the shaft portion.

In yet another aspect, applying torque involves applying the predetermined torque where the predetermined torque is in a range from approximately 30 in-lbs to 50 in-lbs.

In a further aspect, the applying torque step involves applying torque to the head portion such that the head portion shears off the shaft portion simultaneously through each perforation of the plurality of perforations.

In a different aspect, the method further comprises advancing the rod through an aperture of the clamp prior to threading the threaded lumen of the nut onto the rod.

In another aspect, the method further comprises, prior to the threading step, positioning a clamp around a first end region of a first pipe and a second end region of a second pipe when a gasket is disposed between the first end region and the second end region.

In accordance with another aspect of the present disclosure, a torque-limiting fastener system includes: a nut including: a head portion extending from a first end to a second end and including a first lumen extending longitudinally therethrough; a shaft portion extending from the second end of the head portion to a free end and including a second lumen in operative communication with the first lumen, the second lumen extending longitudinally through the shaft portion; and a plurality of perforations disposed at intervals around a periphery of at least one of the head portion and the shaft portion, the plurality of perforations being proximate a transition region in between the head portion and the shaft portion. In this arrangement, the transition region forms a frangible connection between the head portion and the shaft portion. The system also includes first and second pipe segments; a gasket; and a clamp configured to secure the gasket between the first and second pipes, the clamp including a fastener. The nut is configured to engage the fastener to close the clamp and form a sealed connection between the first and second pipe segments.

In another aspect, the fastener includes male threads configured to threadably engage female threads defined by the first lumen of the shaft portion of the nut.

In a different aspect, a perforation of the plurality of perforations includes a cylindrical channel formed through the opening of the head portion along the longitudinal axis of the head portion and through an outer surface of the shaft portion.

In a further aspect, the cylindrical channel is formed through an entire length of the head portion from the first end to the second end.

In another aspect, the cylindrical channel is formed through the second end of the head portion and through an adjacent first end of the shaft portion, the second end of the head portion abutting the first end of the shaft portion.

In a further aspect, the fastener is configured to extend through the cannula of the shaft portion and through the central opening of the head portion.

### BRIEF DESCRIPTION OF THE DRAWINGS

A more complete appreciation of the subject matter of the present disclosure and the various advantages thereof can be realized by reference to the following detailed description, in which reference is made to the following accompanying drawings:

FIG. 1 is a perspective view of a torque-limiting nut according to one embodiment of the present disclosure.

FIG. 2 is another perspective view of the torque-limiting nut of FIG. 1.

FIG. 3 is a top view of the torque-limiting nut of FIG. 1.

FIG. 4 is a bottom view of the torque-limiting nut of FIG. 1.

FIG. 5 is a side view of the torque-limiting nut of FIG. 1.

FIG. 6 is another side view of the torque-limiting nut of FIG. 1.

FIG. 7 is a perspective view of the torque-limiting nut of FIG. 1.

FIG. 8 is a perspective view of a torque-limiting nut according to an embodiment of the present disclosure.

FIG. 9 is another perspective view of the torque-limiting nut of FIG. 8.

FIG. 10 is a top view of the torque-limiting nut of FIG. 8.

FIG. 11 is a side view of the of the torque-limiting nut of FIG. 8.

FIG. 12 is a perspective view of the torque-limiting nut of FIG. 8.

FIGS. 13A-13B are perspective views of a torque-limiting nut according to an

embodiment of the present disclosure.

FIGS. 14A-14B are perspective view of a torque-limiting nut according to an embodiment of the present disclosure.

FIGS. 15A-15B are perspective views of a torque-limiting nut according to an embodiment of the present disclosure.

FIGS. 16A-16B are perspective views of a torque-limiting nut according to an embodiment of the present disclosure.

FIGS. 17A-17B are perspective views of a torque-limiting nut according to an embodiment of the present disclosure.

FIGS. 18A-18C are perspective views of a torque-limiting nut according to an embodiment of the present disclosure.

FIGS. 19A-19C are perspective views of a torque-limiting nut according to an embodiment of the present disclosure.

FIG. 20 is a perspective view of the torque-limiting nut of FIG. 1 implemented with a piping system.

### DETAILED DESCRIPTION

Reference will now be made in detail to the various embodiments of the present disclosure illustrated in the accompanying drawings. It should be noted that the drawings are in simplified form and are not drawn to precise scale. Additionally, the term “a.” as used in the specification, means “at least one.” The terminology includes the words above specifically mentioned, derivatives thereof, and words of similar import. Although at least two variations are described herein, other variations may include aspects described herein combined in any suitable manner having combinations of all or some of the aspects described.

As used herein, the terms “about.” “approximately,” “generally.” and “substantially” are intended to mean that slight deviations from absolute are included within the scope of the term so modified. To aid the Patent Office and any readers of any patent issued on this application in interpreting the claims appended hereto, Applicant notes that it does not intend any of the appended claims or claim elements to invoke 35 U.S.C. § 112 (f) unless the words “means for” or “step for” are explicitly used in the particular claim.

In describing the embodiments of the disclosure, references made to directional nomenclature will be made based on an operator implementing the fastener described herein. It should be appreciated by persons of ordinary skill that this nomenclature is used only for convenience and that it is not intended to be limiting with respect to the scope of the present disclosure. As used herein, the term “proximal” means closer toward the operator, and the term “distal” means further away from the operator.

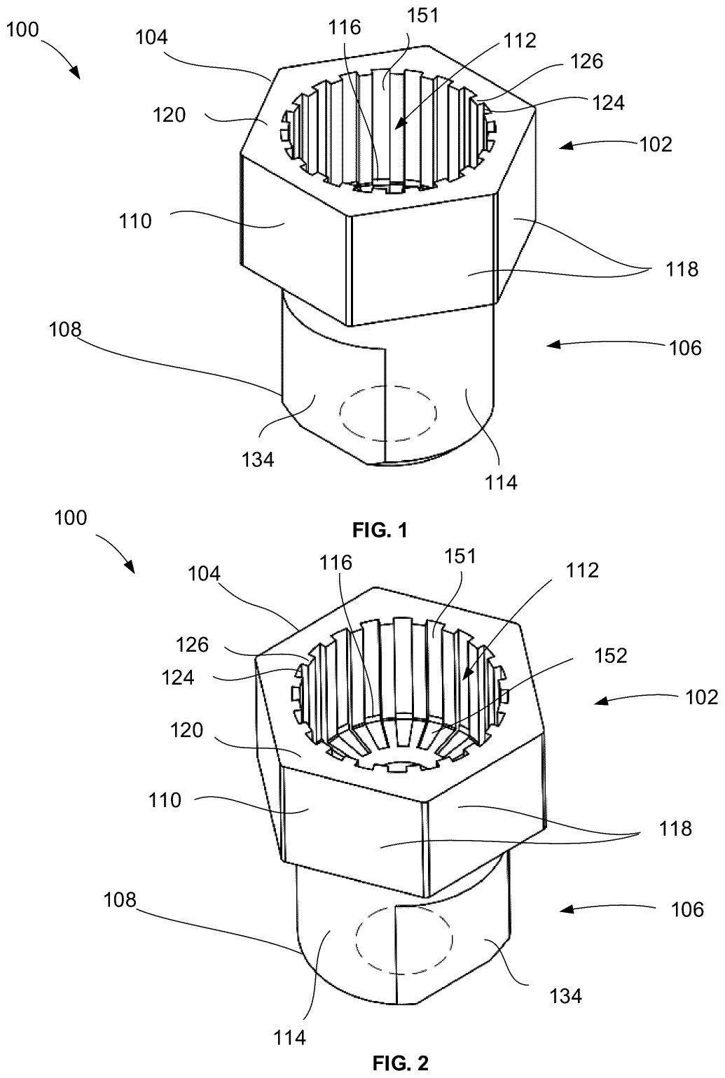

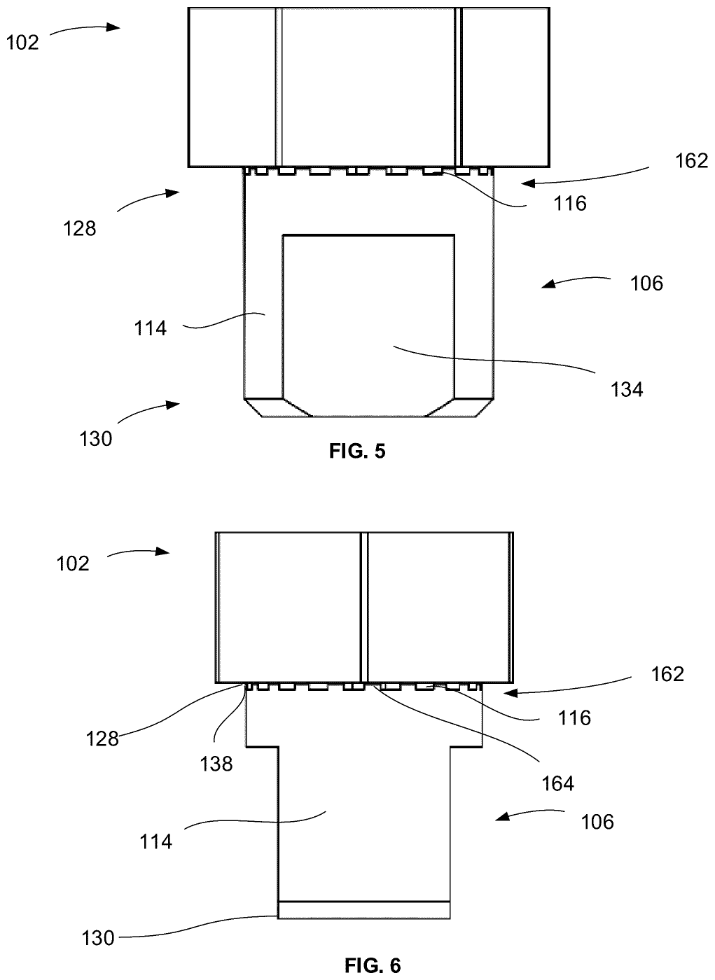

In one aspect, the present disclosure relates to a torque-limiting fastener. In some embodiments, the fastener is a nut that may be used in pharmaceutical or food processing settings to secure pipe ends or pressure vessels. FIG. 1 is a perspective view of a torque-limiting nut 100 according to one embodiment of the present disclosure. Torque-limiting nut 100 includes a head portion 102 at a proximal end 104 and a shaft portion 106 at a distal end 108. The head portion 102 includes an outer surface 110 surrounding a lumen or central opening 112 and the shaft portion 106 includes an outer surface 114 surrounding cannula 140. The shaft portion 106 is frangibly connected to a distal end of the head portion 102 via a plurality of perforations 116. Such perforations may also be referred to as apertures throughout the present disclosure. In nut 100, each perforation 116 extends through an underside of the head portion 102 and through the shaft portion 106 as shown in FIG. 5. The plurality of perforations 116 collectively pass through a shear plane such that when an operator applies a torque equal to or greater than a predetermined value, the head portion 102 shears off of the shaft portion 106, as described in greater detail elsewhere in the present disclosure.

FIGS. 1-7 illustrate various views of the torque-limiting nut 100. Head portion 102 extends toward the proximal end 104 of torque-limiting nut 100 such that an operator can access the head portion 102 with a tool, such as a socket wrench, to tighten or loosen the torque-limiting nut 100. Head portion 102 includes an outer surface 110 that allows an operator to engage the head portion 102 with a tool. As such, outer surface 110 may include any number of faces that engage a corresponding socket or other tool. As depicted, outer surface 110 has a hexagonal shape with six faces 118, however, square, triangular or other outer peripheral shapes are also contemplated. Among the contemplated variations, each face 118 may have a width that is equal to the width of each other faces 118 of head portion 102.

The Nut 100 includes a central longitudinal axis therethrough. A central opening 112 is defined by an inner wall surface of the head portion 102 and is centered along the longitudinal axis. Central opening 112 may be generally circular and extends longitudinally through an entire length of head portion 102 from a proximal end 104 to a base of the head portion abutting the shaft portion. Due to the generally cylindrical shape of the central opening 112 and the flat outer faces 118, a wall 120 having a thickness is defined between the outer surface 110 and the inner wall surface of central opening 112. As illustrated in FIGS. 1-4, wall 120 has a thickness that varies along the width of each outer face 118. The wall 120 is thinner at a midpoint of the width of each outer face 118 and is thicker at the vertices of the outer faces 118.

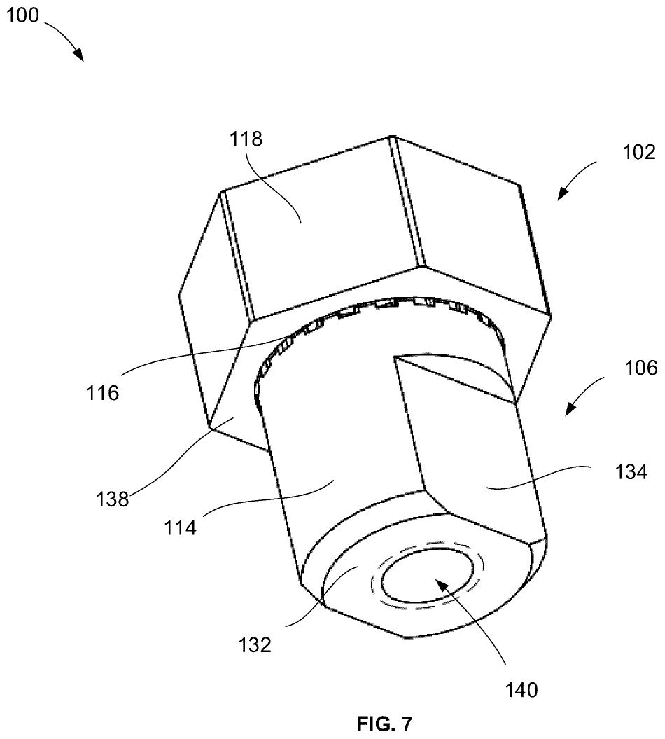

In nut 100, the plurality of perforations 116 extend from an underside of head portion 102 on an outer surface 114 of shaft portion, as shown in FIGS. 5-6, into central opening 112 as shown in FIGS. 1-2. In nut 100 shown in FIGS. 1-7, there are twenty perforations distributed annularly at approximately equal spacing around a periphery of the central opening 112. In other examples, the plurality of perforations may include a greater or lesser number of perforations, differently shaped perforations, and such perforations may be distributed at varying spacing or in other patterns of spacing. A size of each perforation and a spacing of each perforation relative to adjacent perforations may be varied relative to an overall size of the nut to alter a predetermined torque value for the nut. The predetermined torque value is a torque that, when reached, causes the head portion 102 to shear off the shaft portion 106. Each perforation 116 is rectangular in shape. In other examples, the perforations may be partially cylindrical or have other shapes. Further, in a proximal direction from each perforation 116 is a longitudinal recess 151, best shown in FIGS. 1 and 2., and in an inward radial direction toward the central longitudinal axis of the fastener from each perforation is radial recess 152. In some examples, as with nut 100, longitudinal recesses 151 may extend along the entire length of head portion 102. In other examples, such recesses may extend less than the entire length of the head portion 102 as measured from the base of central opening 112. For instance, the recesses 151 may extend halfway along the length of head portion 102 from a midpoint of the length of head portion 102 to the distal end of head portion 102. In further examples, the recesses 151 may extend three-quarters along the length of head portion 102 from a midpoint of the length of head portion 102 to the distal end of head portion 102. In some embodiments, the recesses 151 may extend from the proximal end 104 of head portion 102 to a transition region 162 defined between the head portion 102 and the shaft portion 106, and may extend into the shaft portion. In still further embodiments, the perforations may be entirely disposed within the shaft portion 106 and within the transition region 162 and may not extend into the head portion 102.

The perforations 116 extend from central opening 112 through the wall of the shaft portion and/or the head portion. Accordingly, the distance between a first end 144 of the radial recess 152 and a corresponding outer face 118 is a difference between a radius of central opening 112 and a radius of distal portion 106. Such distance between an inner end of the perforation and an outer end of the perforation may be referred to as a radial dimension of the perforation. In between each adjacent perforation 116 along a transition region 162 is a transition wall 164 having a thickness generally the same as the radial dimension of the perforation. In other embodiments where the perforations extend through part of the head portion 102, a length of the perforations may vary depending on the location of the perforation along the periphery. Examples of such dimensions may include a first end 144 of perforation 116 being from approximately 1 mm to approximately 5 mm away from an outer face 118 along a midpoint of the width of outer face 118. At other locations along the periphery and/or in other examples, the dimension may be greater than 5 mm.

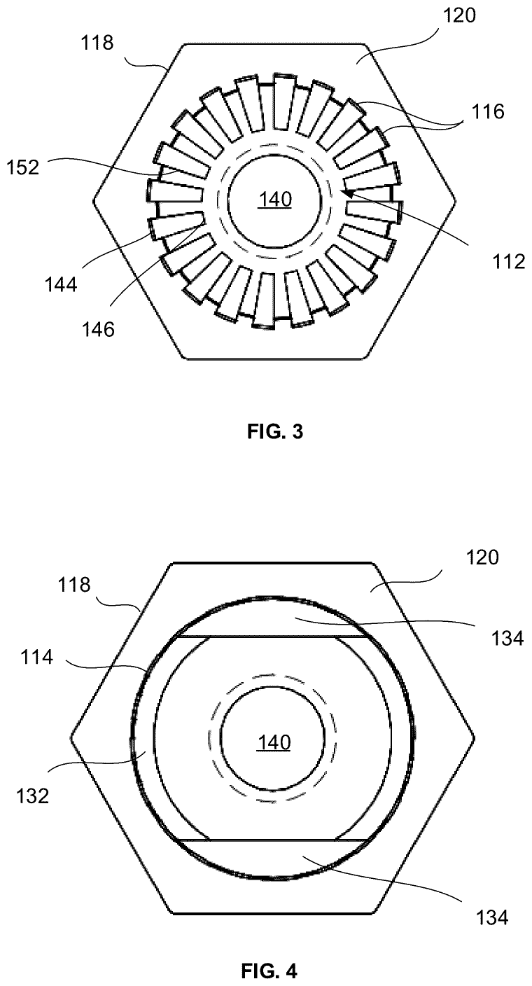

As depicted in FIGS. 1-3, each perforation 116 is a rectangular slot with respective recesses extending longitudinally and radially therefrom. Radial recess 152 is at least partially rectangular when viewed from above, as shown in FIG. 3. Such recess may be rectangular and have two pairs of parallel sides, trapezoidal with one pair of parallel sides, or polygonal with no pairs of parallel sides. As depicted, the radial recess 152 extends from a wider first end 144 to a narrower second end 146. One having ordinary skill in the art would appreciate that the exact configuration and shape of the perforations and associated recesses may be modified to achieve a desired result (i.e., a specific predetermined torque at which shearing of the head portion from the shaft portion occurs).

The perforations 116 of torque-limiting nut 100 may be arranged (i.e., the number, size, and ratio of perforations to perimeter of the nut may be adjusted during manufacturing) to produce a desired torque in which the head portion 102 shears away from the shaft portion 106. For example, to produce a torque-limiting nut 100 with a lower predetermined torque-limiting value, a quantity of apertures around a periphery of the nut may be increased from an initial quantity. Similarly, such performance adjustment may also be obtained by increasing a size of the apertures relative to an initial aperture size. An increase of the predetermined torque-limiting value may similarly be obtained by adjusting the design of the apertures in an opposite manner. In general, the designs of the present disclosure may provide predetermined shear values on a scale of inch-pounds, such as torque limits that are less than 100 in-lbs to reach shear failure where the head portion breaks off from the shaft portion. In many examples, a design may be tailored to have a predetermined torque in a range from approximately 30 in-Ibs to approximately 50 in-lbs of torque to shear the head portion 102 away from the shaft portion 106. Accordingly, one of ordinary skill in the art would appreciate that the contemplated arrangements of torque-limiting nut 100 may provide maximum torque values on the order of in-lbs, rather than ft-lbs. As such, torque-limiting nuts 100 may be designed to shear at any value between approximately 10 in-lbs and approximately 100 in-lbs. Specific examples include nuts designed to shear at 20, 25, 30, 35, 40, 45, 50, 55 or 60 in-lbs. In some examples, the design may provide a torque-limiting value that is accurate to within 3 in-lbs, such that a nut with a torque-limiting value of 30 in-lbs may be expected to shear at a torque between 27 and 33 in-lbs. Tolerances and materials may be utilized to adjust an expected range for a torque limit. Examples of nut sizes fabricated for such performance include ½ inch diameter, ⅝ inch diameter and ¾ inch diameter nuts. Such sizes are merely exemplary and the concepts described in the present disclosure are not limited to the aforementioned sizes.

FIGS. 5-6 illustrate a shaft portion 106 of nut 100. Shaft portion 106 extends along a longitudinal axis from a proximal end 128 to a distal end 130. Shaft portion 106 may be partially cylindrical and thus may define a circular outer surface 114. Outer surface 114 may be substantially smooth throughout or may optionally also include diametrically opposed flats 134. Such flats may ease removal of the nut 100 from an existing securement arrangement. The diameter of the outer surface 114 may be equal to or greater than the diameter of the central opening 112 of head portion 102.

Shaft portion 106 includes a cannula 140 extending along a central longitudinal axis of the shaft portion 106, the cannula 140 being in operative communication with central opening 112, as shown in FIG. 3. Cannula 140 may be defined by an inner wall that includes threads that extend through all or a part of the cannula. Such threads may correspond to threads of a rod, bolt or other fastener to provide for engagement of the nut with such rod, bolt or other fastener. As such, the diameter of cannula 140 may be formed to correspond to different diameter fasteners for different applications. Cannula 140 extends entirely through shaft portion 106 from the proximal end 128 to the distal end 130. In some examples, cannula 140 may extend only partially through shaft portion 106A. A wall 132 of the shaft portion extends between the inner surface of the cannula 140 and the outer surface 114 of the shaft portion.

FIGS. 5-6 illustrate a transition region 162 for nut 100. Transition region 162 includes a step 138 extending a distance from the perimeter of head portion 102 to the outer surface 114 of the shaft portion 106. Step 138 may be formed at right angles with respect to an outer surface 110 of head portion 102 and an outer surface 114 of shaft portion 106. In alternative embodiments, a diameter of the shaft portion 106 may greater relative to a diameter of the head portion 102 than that depicted in FIGS. 1-7.

In a variation of nut 100, the recesses 151, 152 may have beveled or otherwise rounded edges either partially or throughout their respective lengths. In this manner, the recesses may include concave and convex surface portions. The inclusion of rounded edges on the recesses may simplify cleaning of the nut and may reduce the likelihood that unwanted particulates accumulate on the nut.

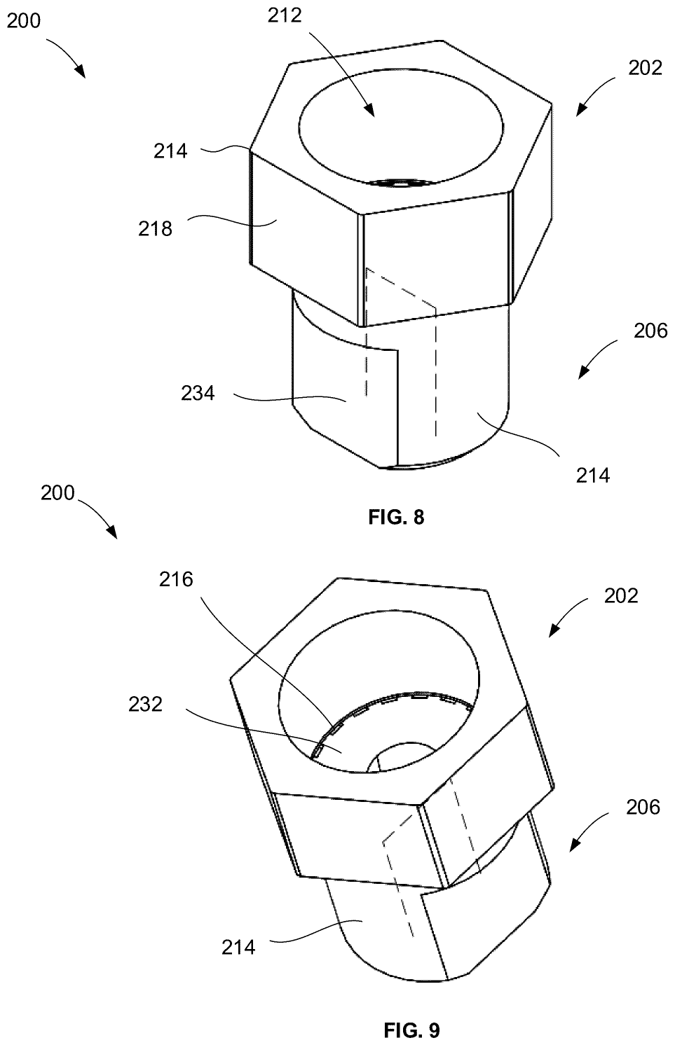

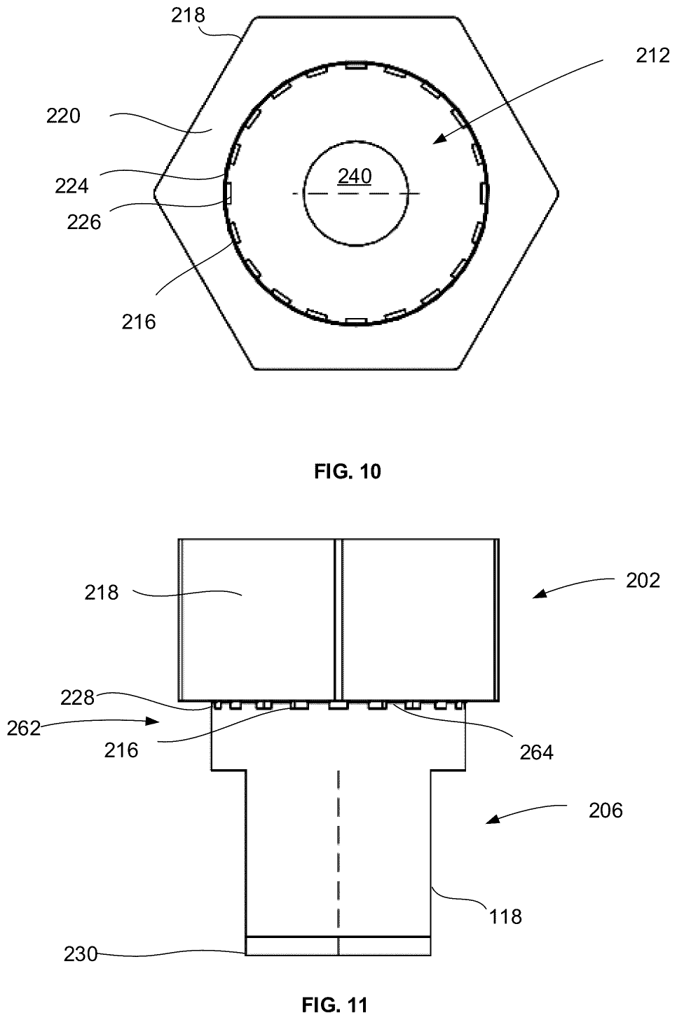

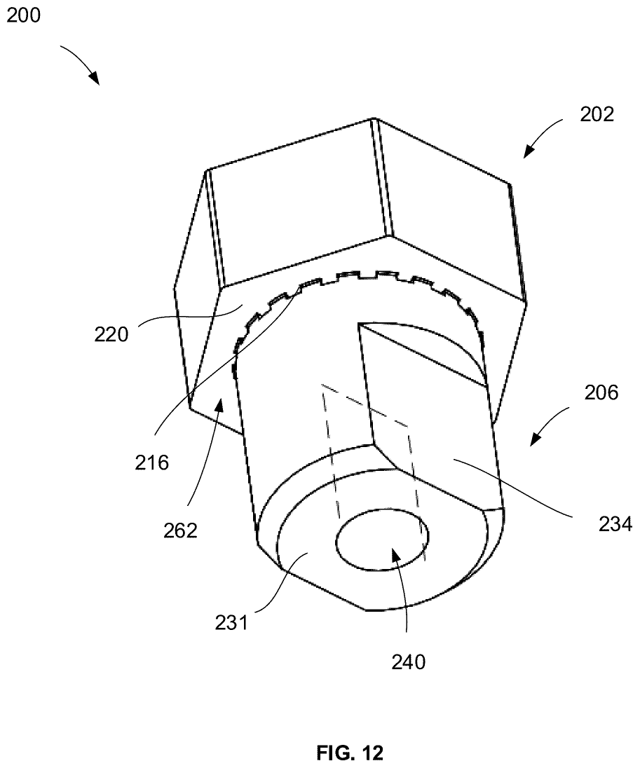

FIGS. 8-12 illustrate another embodiment of a torque limiting nut 200. In FIGS. 8-12, reference numerals in the 200-series of numerals refer to like reference numerals in the 100-series of numerals in FIGS. 1-7, unless otherwise indicated. In this embodiment, nut includes head portion 202 and shaft portion 206 extending from the head portion. A plurality of perforations 216 are distributed annularly and at approximately equal spacing around a periphery of central opening 212, as shown in FIG. 10. Each perforation 216 of the plurality of perforations extends through a wall in the shaft portion 206 from an outer surface 214 of shaft portion 206 to an inner base surface of central opening 212, as shown in FIGS. 10 and 11. A radial dimension of each perforation may be a difference between the radius of the shaft portion and the radius of the central opening. In between each perforation 216 along a transition region 262 is a transition wall 264 having a thickness generally the same as the radial dimension of the perforation. Each perforation may further extend radially inward into the central opening beyond the radial dimension, as shown in FIG. 10. In this manner, the plurality of perforations 216 on the outer perimeter 214 of shaft portion 206 may define respective peaks 226 and valleys 224 corresponding to the size and number of perforations 216 on the nut 200. Additionally, it should be appreciated that all design variations contemplated for nut 100 may be applied to nut 200 and as such are contemplated by the present disclosure.

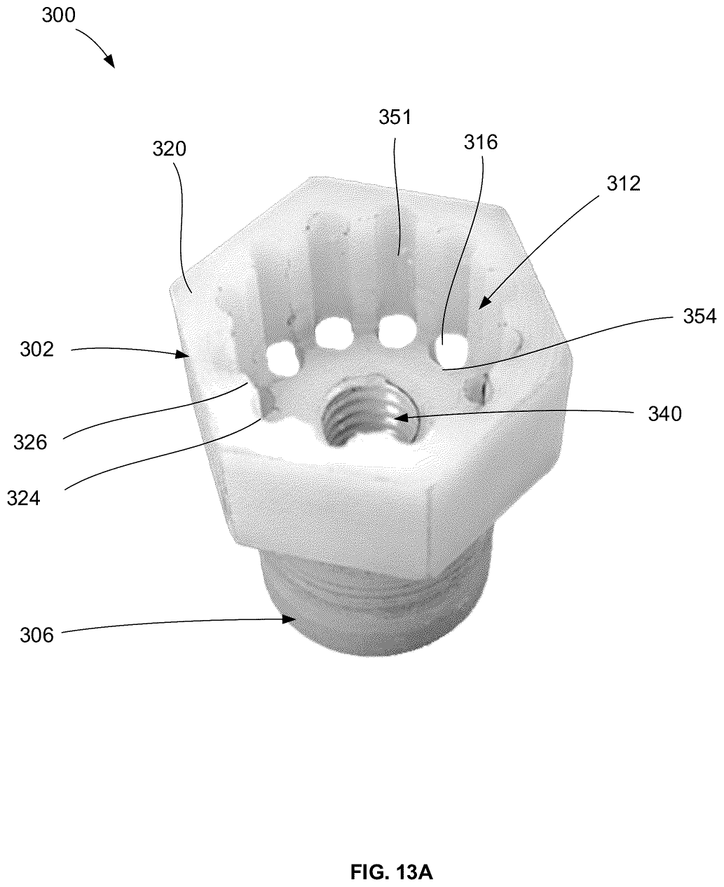

FIGS. 13A-13B illustrate yet another embodiment of a torque limiting nut 300. In FIGS. 13A-13B, reference numerals in the 300-series of numerals refer to like reference numerals in the 100-series of numerals in FIGS. 1-7, unless otherwise indicated. Torque-limiting nut 300 includes a plurality of perforations 316 that are cylindrical or partially cylindrical in shape. As with other embodiments described herein, the perforations of the plurality of perforations are distributed around a periphery of the central opening 312 and are generally equally spaced. Each perforation is radially disposed through the nut such that part of the perforation is outside of a diameter of the shaft portion 306 and part of the perforation is inside of the diameter of the shaft portion 306. In this manner, a pathway of a cut in the material of the nut to form the perforation is parallel to a central longitudinal axis of the nut. Moving in a proximal direction away from perforation 316, an outside periphery of perforation 316 continues as longitudinal recess 351 as shown in FIG. 13A. Moving in a distal direction from perforation 316, an inside periphery of perforation 316 continues as longitudinal recess 354 as shown in FIG. 13B. In some examples, perforations 316 may be formed such that longitudinal recesses 351, 354 may have a half-cylindrical cross-sectional shape. Such a configuration defines repeating valleys 324 and peaks 326 on an inner surface defining the central opening 312. Accordingly, adjacent cylindrical perforations can share a peak 326 between each respective valley 324. The number and size of peaks 326 and valleys 324 may be designed to correspond to the specific torque desired to shear the head portion 302 from the shaft portion 306. As such, nuts with larger peaks 326 may require more torque to induce shearing than a nut with smaller peaks 326. two or more perforations 316 of the plurality of perforation may be spaced at uniform distances from an outer diameter of head portion 302 and with respect to each other. For example, each perforation may be positioned 0.5 mm or 1 mm from an outer perimeter of head portion 302, or at greater distances from the outer perimeter. Further, each perforation may have a diameter that is in a range of 5-25% of a diameter of the shaft portion. An example of such a dimension includes a ratio of 1:10 between the diameter of cylindrical perforation 316 and the diameter of the shaft portion. It should be appreciated that such ranges and values are merely illustrative and are not intended to be limiting. Further, it should be appreciated that all design variations contemplated for nut 100 may be applied to nut 300 and as such are contemplated by the present disclosure.

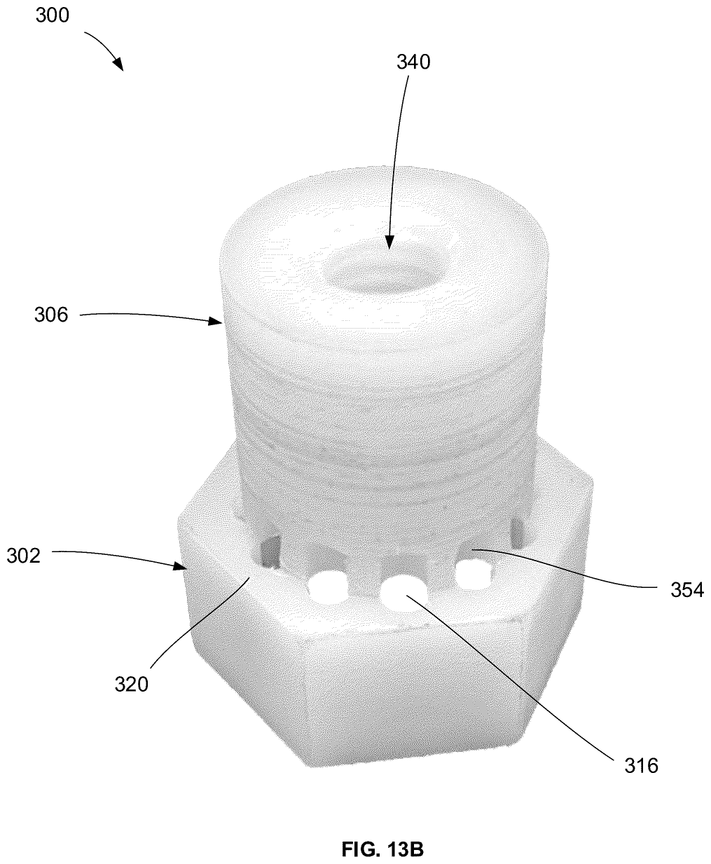

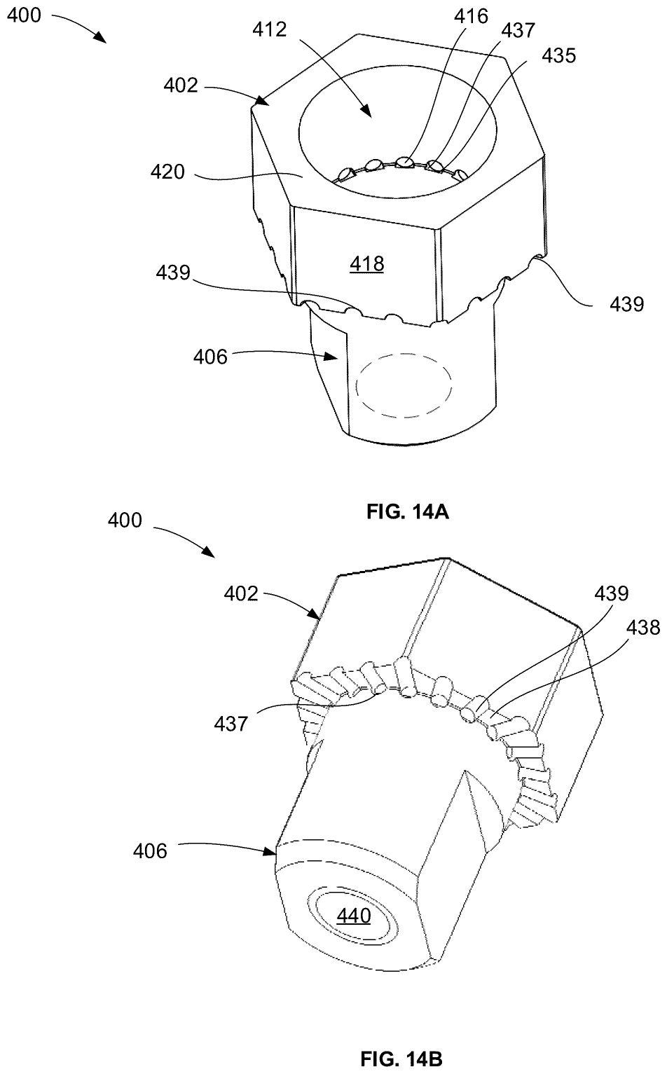

In yet another embodiment, a torque-limiting nut 400 is shown in FIGS. 14A-14B. In FIGS. 14A-14B, reference numerals in the 400-series of numerals refer to like reference numerals in the 100-series of numerals in FIGS. 1-7, unless otherwise indicated. Nut includes a head portion 402 and a shaft portion 406. On an underside surface 438 of the head portion are a plurality of partially cylindrical radially oriented recesses 439. Each recess 439 extends from an outside surface 418 of the head portion toward a central axis of the fastener, and extends into a central opening 412 of the head portion. At an interface with an outer surface of the shaft portion, apertures 416 are formed that are defined in part by a surface 439 of the head portion and a surface 437 of the shaft portion. The portion of the aperture that is formed in the surface 437 of the shaft portion extends into the central opening and has an end surface 435 at a slightly lesser radial distance from the central axis of the fastener than the radius of the central opening 412.

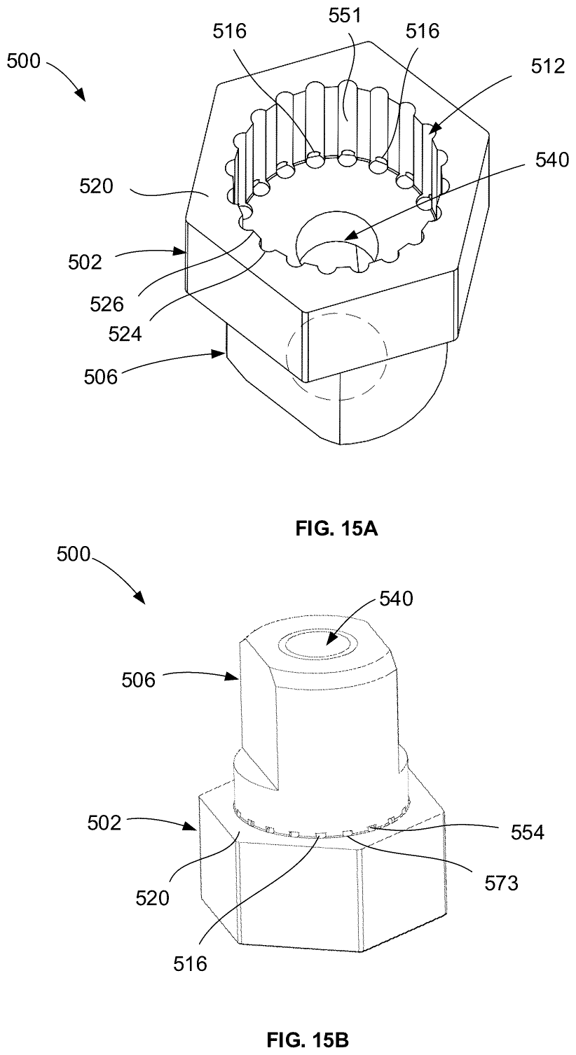

In yet another embodiment, a torque-limiting nut 500 is shown in FIGS. 15A-15B. In FIGS. 15A-15B, reference numerals in the 500-series of numerals refer to like reference numerals in the 300-series of numerals in FIGS. 13A-13B, unless otherwise indicated. Nut 500 includes a head portion 502, a shaft portion 506, and a plurality of longitudinal recesses 551 that are partially cylindrical or rectangular in shape and are distributed around a periphery of the central opening 512 through the head portion 502, as shown in FIG. 15A. In some examples, and as shown, the recesses 551 may extend into a base of the central opening. Within each longitudinal recess 551, and oriented radially relative to a longitudinal dimension of the nut, are a plurality of perforations 516. Such perforations extend radially outward through the shaft portion 506 to an outer surface of the shaft, as shown in FIG. 15B. As with other embodiments, the plurality of perforations 516 may be generally equally spaced around a periphery of the central opening 512. Each radially oriented perforation of the plurality of perforations 516 may have a rectangular or ovular shape with edges on an outside surface of the nut such that some of the edges are on the shaft portion and other edges are on the head portion, as shown in FIG. 15B. It should be appreciated that the specific orientation of a lower surface 554 and upper surface 573 of perforation 516 may be modified, and that a shape of the opening may be modified to suit particular manufacturing techniques.

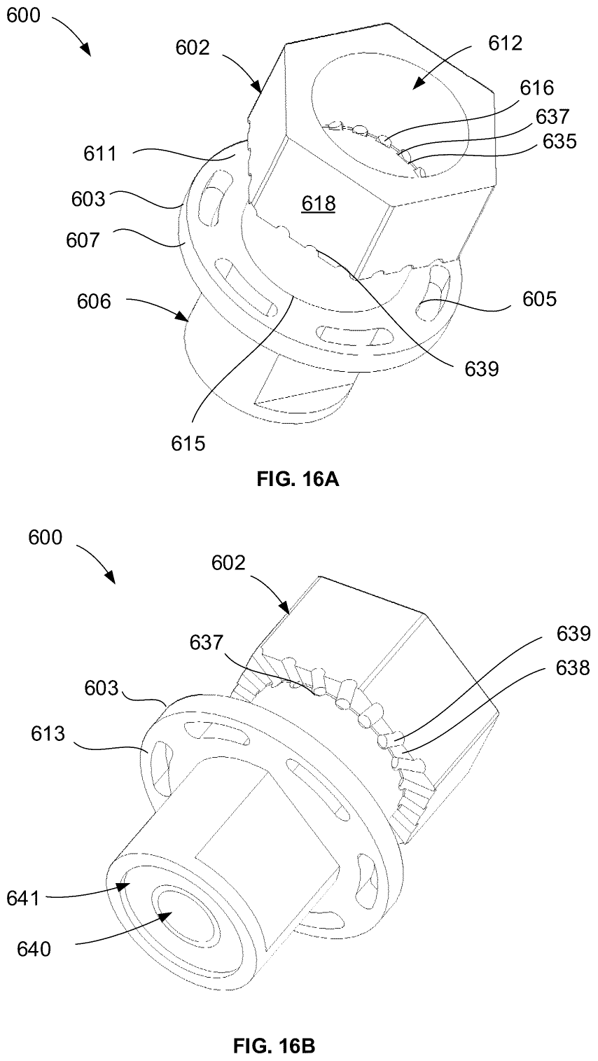

In yet another embodiment, a torque-limiting nut 600 is shown in FIGS. 16A-16B. In FIGS. 16A-16B, reference numerals in the 600-series of numerals refer to like reference numerals in the 400-series of numerals in FIGS. 14A-14B, unless otherwise indicated. Accordingly, only the differences between nut 600 and nut 400 are described below. Nut 600 includes a ring 603 that is positioned around a perimeter of shaft portion 602. Ring 603 may function to hold a wire or similar structure so that another end of the wire may be secured to a fixed location. In this way, the ring and wire combination provides a way to visualize whether the nut has been tampered with. Further, when an installed nut is ready for removal from a secured location over a rod or other fastener, the securement of ring to a fixed location via the wire may ensure that the shaft portion 606 is not lost once it is removed. Shaft portion 606 may further include a circular recess 641 at a distal end that is in operative communication with lumen 640.

Ring 603 may be circular as illustrated in FIGS. 16A-16B, or it may have straight segments to define hexagonal, octagonal, or other shapes. Ring 603 includes an inner diameter 615 that corresponds to an outer diameter of shaft portion 602. Ring 603 extends form a top surface 611 to a bottom surface 613, the distance between surfaces defining a ring thickness 607. One or more openings 605 may be formed entirely through the ring thickness 607 to allow a user to casily grasp ring opening 605 and so that wire may be secured to ring through such opening(s). Ring 603 may be integrally formed with shaft portion 606 through manufacturing methods such as machining or molding, or may be fixed to shaft portion via welding, adhesives, or the like. In other embodiments, additive manufacturing techniques may be used.

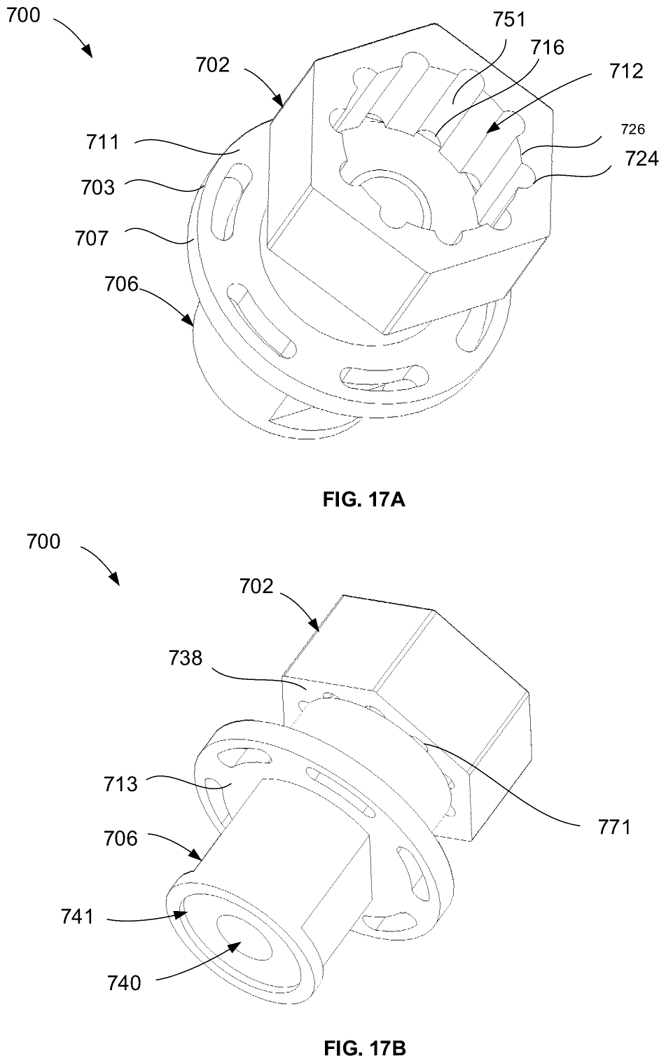

In yet another embodiment, a torque-limiting nut 700 is shown in FIGS. 17A-17B. In FIGS. 17A-17B, reference numerals in the 700-series of numerals refer to like reference numerals in the 500-series and 600-series of numerals in FIGS. 15A-15B and 16A-16B, unless otherwise indicated. Nut 700 includes a head portion 702 and a shaft portion 706. A ring 703 extends around shaft portion 706 to allow a user to attach a wire to the ring 703. As with other embodiments, the nut 700 includes a plurality of perforations 716 that are generally equally spaced around a periphery of the central opening 712. Further, a pathway of a cut or mold in the material of the nut 700 to form the longitudinal recesses 751 and the perforations 716 is parallel to a central longitudinal axis of the nut 700. In nut 700, the head portion and the shaft portion are shaped such that the perforations 716 are longitudinally oriented and extend out of a distal end surface 738 of the head portion at opening 771, as shown in FIG. 17B. Opening 771 does not extend into shaft portion 706, but rather terminates at a transition region between head portion 702 and shaft portion 706 and opens distally outside of head portion 702. Opening 771 may have a semicircular shape as illustrated in FIGS. 17A-FIG.17B, or another shape that may correspond with the respective recess 751.

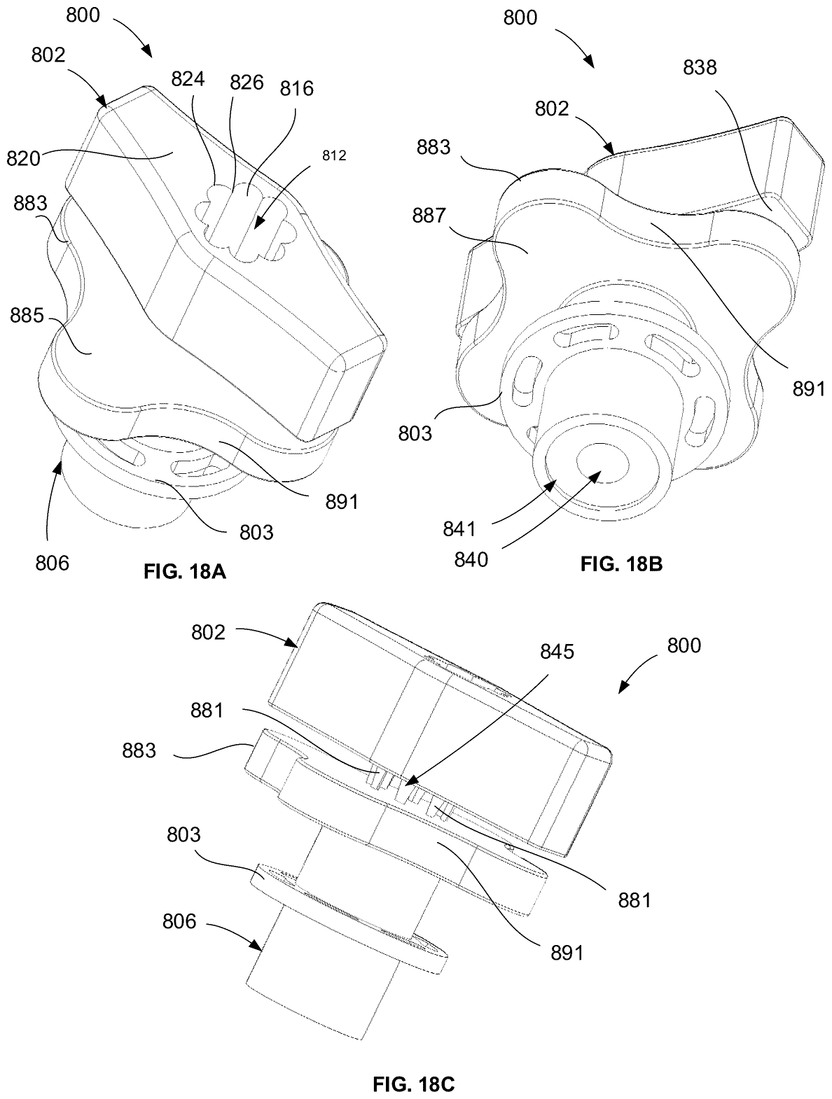

In yet another embodiment, a torque-limiting nut 800 is shown in FIGS. 18A-18C. In FIGS. 18A-18C, reference numerals in the 800-series of numerals refer to like reference numerals in the 100-series through the 700-series of numerals of numerals in FIGS. 1-17B, unless otherwise indicated.

Nut 800 includes a head portion 802, a shaft portion 806, a ring 803, and a base 883. Head portion 802 is wing-nut or handle-shaped rather than hexagonal shaped. Such a shape allows a user to apply a torque to head portion 802 by hand with the need for a tool. Head portion 802 extends from an upper side 820 to a lower side 838 and defines a thickness therebetween. Along a central longitudinal axis of the nut, and as best shown in FIG. 18A, is a central opening 812 with an outer perimeter defined by a plurality of longitudinally-oriented grooves 816. The plurality of grooves 816 extend through the thickness of the head portion 802 from the upper side 820 to the lower side 838 such that the central opening passes through both upper and lower sides. The grooves 816 are directly adjacent to each other and thus define respective peaks 826 that come to a longitudinal edge rather than forming a flat plateau, although such shape may be varied in other embodiments. The grooves 816 extend longitudinally and may each have concave surfaces that have a uniform radius of curvature or a substantially uniform radius of curvature.

From lower side surface 838 of the head portion 802, a plurality of fins 881 extend to connect head portion 802 with an upper end 885 of base member 883. The plurality of fins 881 may be fewer in number to the plurality of grooves 816 or the fins may be of equal number to the plurality of grooves 816. Each fin may have an interior facing surface that is continuous with grooves 816, but with a width that tapers in a distal direction, as best shown in FIG. 18C, such that the fins become narrower toward base member 883. In such examples, the interior facing surfaces of the fins may be concave and may include a sharp ridge 826. Because the fins 881 are distributed in a spaced apart manner in an annular fashion, the spaces between the respective fins are collectively a plurality of perforations 845, or apertures. In some examples, fins 881 may be rectangular and taper from a proximal end towards a distal end such that fins 881 are narrowest as they attach to base member 883. A tapered fin shape allows for a clean break as head portion 802 is torqued and sheared from shaft portion 806 such that no portion of fins 881 remain attached to base member 883. The size and shape of fins 881 may be modified to correspond to a specific torque value desired to shear head portion 802 from shaft portion 806. Similarly, a spacing between head portion 802 and base member 883 may be varied for the same reasons.

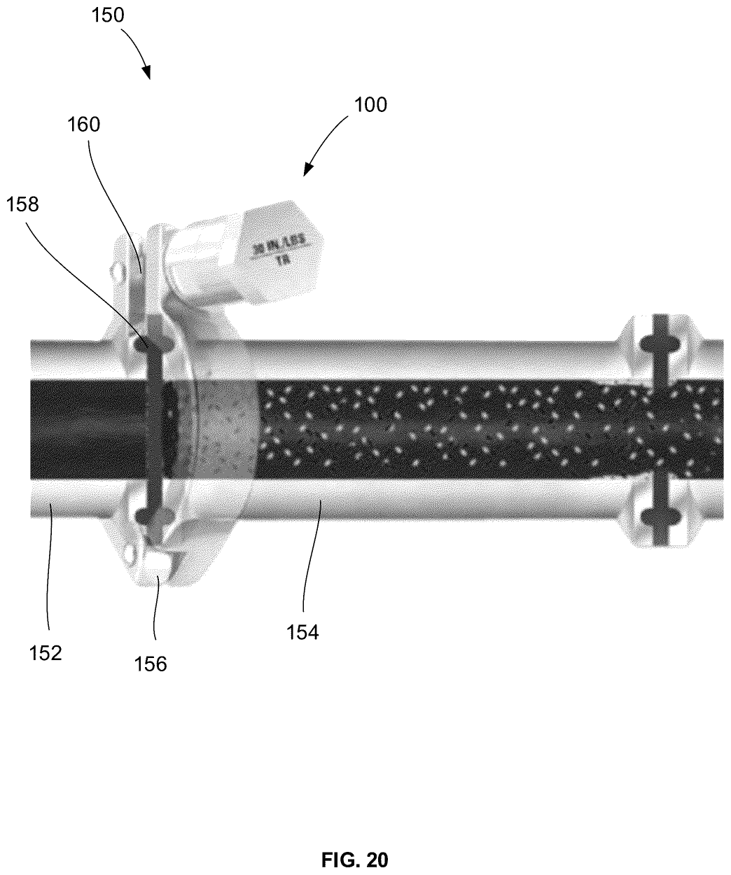

Base member 883 is positioned at a proximal end of shaft portion 806 and at a distal end of fins 881. Base member 883 may be planar and defines an upper surface 885, a lower surface 887, and a thickness therebetween. Base member 883 may have various curved portions 891 that aid a user in various ways. During securement of the nut 800 onto a rod or other fastener in a method such as that shown in FIG. 20 and described below, a user will be inclined to hold only the wing nut 802 due to the shape of the base member 883. In this manner, the shape of the base member 883 makes it more difficult for an operator to accidentally grip both the wing nut 802 and the base member 883 when seeking to apply torque to the nut, thereby avoiding a situation where the entire nut is torqued instead of just the head portion 802 as intended. And, during removal of the shaft portion from a previously installed condition, the base member 883 may be grasped and rotated to rotate and detach the shaft portion 806. To suit the above purposes, the base member 883 may be cloverleaf shaped or have another shape that allows a user to easily grasp and apply torque to the shaft portion 806 to remove shaft portion 806 from a fastener 160 of a clamp 156 when nut has previously been deployed with a predetermined torque onto a fastener.

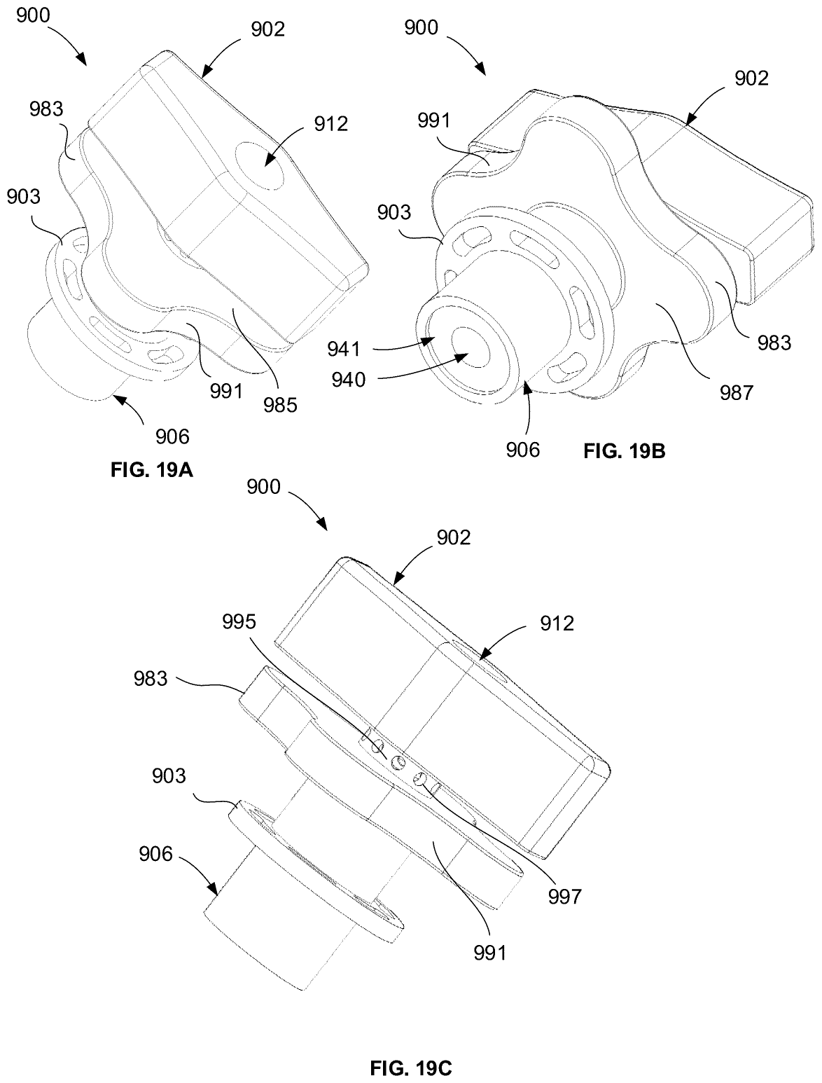

In yet another embodiment, a torque-limiting nut 900 is shown in FIGS. 19A-19C. In FIGS. 19A-19C, reference numerals in the 900-series of numerals refer to like reference numerals in the 800-series of numerals in FIGS. 18A-18C, unless otherwise indicated.

Nut 900 includes a head portion 902, base member 983, shaft portion 906, and a ring 903. Head portion 902 may be a wing nut or similar handle shape that allows a user to apply a torque by hand to head portion 902 without the use of tools. Head portion 902 includes a central opening 912. Central opening 912 may be substantially smooth and lack recesses or other features around its perimeter. A perforation disk 995 is positioned distal of handle portion 902 and proximal of base member 983. Perforation disk 995 is circular and may be shaped such that a longitudinal axis of the perforation disk coincides with the longitudinal axis of nut 900. Perforation disk 995 includes a plurality of cylindrical perforations 997 spaced annularly around the perforation disk, each being formed through an outer sidewall of perforation disk 995 in a direction transverse to the longitudinal axis of nut 900, e.g., extending radially outward from the longitudinal axis of nut 900. Each perforation 997 is in operative communication with the central opening 912. The size and number of cylindrical perforations 997 may be modified in order to achieve a desired torque at which head portion 902 shears away from base member 983 and shaft portion 906.

For each of the aforementioned embodiments, the head portion, fins, base member, ring, and shaft portion may be formed through additive manufacturing, machining, molding, and the like, as described elsewhere in the present disclosure. In some manufacturing approaches, the components of the nut may be assembled together via welding, adhesives, or the like.

Torque-limiting nut 100, 200, 300 may be made from a plastic material that is formed through standard processes known in the art, such as additive manufacturing, machining, or molding. Such manufacturing processes allow for torque-limiting nuts 100 to be produced accurately and consistently. Specific materials for producing the torque-limiting nut with a torque-limit value on an order of inch-pounds, e.g., up to 100 in-lbs, include nylon, polysulfone, polytherimide, polypropylene, polytetraflurocthylene, polyetheretherketone and other similar materials. These materials have chemical resistance properties that allow the material to withstand sterilization, which makes such materials ideal for pharmaceutical, food manufacturing, and other similar industries. These materials can also be used for fasteners used within clamps of various clamping systems. Additionally, plastic torque-limiting nuts may be threaded onto plastic or metal fasteners.

In other embodiments, the torque-limiting nut may be formed of metallic materials such as aluminum, zinc, brass or steel. Such materials may suit different applications from the polymeric materials described above, such as automotive, marine and other similar applications. A higher predetermined torque for shear failure is expected with such materials, and may be designed for a torque limit of a target value in a range from 600 in-lbs to 3600 in-lbs.

In still further embodiments, the nut may be formed of a glass-filled composite material. The fastener materials contemplated by the present disclosure may be inherently capable or otherwise prepared using techniques known to persons of skill in the art to withstand industrial sterilization of facilities where the fasteners are used. Such sterilization may involve the use of hydrochloric acid, hydrogen peroxide, phosphoric acid, and so on.

FIG. 20 depicts a clamping system 150. Clamping system 150 includes first and second pipes 152, 154, a gasket 158, and a clamp 156. As shown, clamp 156 is a C-clamp. First and second pipes 152, 154 may be any standard pipes known in the art, such as polyvinyl chloride (PVC), copper, and the like. Gasket 158 may be any standard gasket known in the art, such as metallic, non-metallic, composite, and the like. Clamp 156 may be any standard clamp known in the art, such as a C-clamp, pipe clamp, and the like. Clamp 156 includes a fastener 160 extending through the clamp 156. The fastener 160 may be a screw, bolt, or the like, and may be either metal or plastic. The fastener 160 includes male threads configured to receive the female threads of cannula 140 in nut 100. A torque-limiting nut 100 may be threaded onto the fastener 160 to close the clamp 156 around the first and second pipes 152, 154, which thereby secures gasket 158 between the first and second pipes 152, 154 and creates a hermetic seal. In particular, nut 100 is torqued with a tool such as a torque wrench (not shown) until the torque applied reaches a predetermined torque at which the nut is designed to shear along a shear plane in the transition region 162, shown in FIG. 6, for example. In this way, when the head portion breaks off, an operator will know that the predetermined torque has been applied. This ensures that the clamp does not overly tighten the gasket between the pipes.

Many existing clamping systems have specific drawbacks in industries such as pharmaceutical and food manufacturing. In those industries, potential problems arise when clamps overtighten pipe connections. When a clamp is overtightened, the gasket within the pipes may compress and protrude outward between the two pipes. Such a protrusion increases the risk of potential contaminates accumulating on the gasket within the pipes and could create biohazards or cause other undesired effects. Additionally, when metal fasteners are used, as may be the case in certain industries like those mentioned above, such metal fasteners often need to be removed from piping systems to be sanitized for continued use. In large facilities with many pipe connections, it may become tedious and difficult to remember which fasteners have been sanitized and replaced, thereby increasing the risk of contamination. In contrast, torque-limiting fasteners as contemplated by the present disclosure may be produced on a scale allowing for single use followed by disposal, removing the need to autoclave or sterilize for reuse. Moreover, torque-limiting nuts 100 provide a needed improvement by securing clamps while preventing their overtightening.

Torque-limiting nut 100 has additional advantages over existing torque-limiting systems. Because torque-limiting nut 100 includes apertures or perforations to create a shear plane in which the head portion of the nut shears away from the shaft portion, torque-limiting nut, made of the described nylon or other similar materials, can cleanly shear away from shaft portion between each perforation. Such a design avoids any stretching or deformation of the material prior to shearing off of the head portion even when the torque applied is on a scale of inch-pounds. Accordingly, the fasteners as contemplated by the present disclosure are advantageous over alternative designs as the perforations of such fasteners provide for shear failure based on torque on an inch-pound order of magnitude without stretching or bulging of the material, and allowing for a predictable torque to cause shearing of the polymeric material.

Various torque-limiting nuts 100 may be color-coded or include other indicia such that an operator can readily identify characteristics of specific torque-limiting nuts. For example, a 30 in-lb torque limiting nut may be red, and a 50 in-lb torque limiting nut may be blue. Alternatively, torque-limiting nuts 100 may be color-coded to correspond to a date that the torque-limiting nut is installed. For examples in which nuts need to be replaced annually, torque-limiting nuts replace in a certain calendar year may be red, and torque-limiting nuts replaced in the next calendar year may be green.

In one aspect, the present disclosure relates to a method of fabricating a torque-limiting fastener such as nut 100. Examples of a process of fabricating the fastener are machining and molding. In one example of a machining process, one or more tools are used to form a head portion and a shaft portion of the nut. An opening is then formed within each portion. In some examples, the order of the preceding steps may be modified as desired. This is followed by the formation of the recesses and perforations. As an example, for nut 300, a cylindrical cutting tool is used to form the curved shape defining each complementary recess 351, 354 and perforation 316, all in one step for each peripheral location on the nut. This may be done with a cylindrical cutting tool advanced axially into the nut to form the requisite shape of each perforation and accompanying recess, for example. This step may be repeated for each desired perforation around a perimeter of the central opening 312. A similar process may be performed for nut 100 and 200 and other contemplated embodiments. In one example of a molding process, the head portion and shaft portion of nut 200 may be formed out of a single mold. Then, in a separate step, a tool may be used to create perforations 216 around a perimeter of the nut. Such tool may be applied in an inward radial direction from a location external to the nut. Other nuts may be formed using this process, such as nut 500. In other examples, a mold may be used to form an entirety of nut 200 or other nuts as contemplated by the present disclosure, inclusive of the plurality of perforations that are part of the respective nut. It should be appreciated that additive manufacturing techniques may also be used to form part or all of the fastener structure. And, while particular embodiments of the nut are referenced above, it should be appreciated that any one of the above methods of fabrication may be employed for the formation of the nuts 100, 200, 300, 400, 500, 600, 700, 800, 900 contemplated by the present disclosure.

In another aspect, the present disclosure relates to a method of using a clamping system with a fastener such as nut 100. A method of using the clamping system 150 according to one embodiment is described herein. An operator may first place a gasket 158 between first and second pipes 152, 154. A clamp 156 is then secured around the pipes 152, 154 such that when the clamp is tightened it draws the first and second pipes 152, 154 together around the gasket 158. Once an operator ensures that the gasket is properly aligned between pipes 152, 154, an operator may thread a torque-limiting nut 100 onto a fastener 160 of the clamp 156 to tighten and close the clamp 156.

To tighten the torque-limiting nut 100 to fastener 160, an operator may use a socket wrench or other tool to grasp and turn the torque-limiting nut 100. An operator may engage a socket or other tool with the head portion 102 of torque-limiting nut 100. Torque-limiting nut 100 may then be rotated according to the direction of the threads of fastener 160 to advance the torque-limiting nut 100 along the longitudinal axis of torque-limiting nut 100. As the torque-limiting nut 100 begins to bear on the clamp 156 to draw first and second pipes 152, 154 together, an operator may continue to turn the torque-limiting nut 100 without lowering the torque applied through the tool because the perforations 116 of torque-limiting nut 100 prevent the torque-limiting nut from being overtightened. Accordingly, an operator can continually increase the torque applied to torque-limiting nut 100 until the head portion 102 of torque-limiting nut 100 shears off the shaft portion 106. In alternative embodiments such as those that implement nut 800, 900, an operator may apply torque to the nut 800, 900 by hand by gripping and rotating the head portion 802, 902 and applying torque thereto until the head portion 802, 902 shears away from the shaft portion 806, 906. Once the head portion 102 shears away from the shaft portion 106, the shaft portion remains affixed to the fastener 160 and the head portion 102 is removed and may be discarded. At this juncture, the shaft portion 106 maintains securement of the clamp based on the predetermined torque applied upon the reaching the point of shearing the head portion. Thus, an operator can rely on the knowledge that a predetermined torque has been applied and that the joint is hermetically sealed.

In order to remove shaft portion 106 from fastener 160, an operator may employ any one of a variety of methods. First, an operator may remove shaft portion 106 by extending a tool, such as a socket wrench or adjustable wrench, around shaft portion 106 and turn it in the loosening direction until it is removed from the fastener 160. Alternatively, in embodiments such as nut 800 and nut 900, an operator may remove shaft portion 806, 906 by gripping either the base member 883, 983 or the ring 803, 903, which are both attached to shaft portion 806, 906, and rotating the shaft portion off the fastener. These methods may be advantageous as they do not require an operator to have any additional tools.

In some embodiments, the nut 100 may include a tether or other device that attaches the head portion 102 to the shaft portion 106 or to a clamp 156 such that the head portion 102 remains connected to a stationary structure after the torquing action is complete. When the clamp 156 needs to be removed for maintenance, a wrench or other tool may be placed around the shaft portion 106 to turn the shaft portion 106 in the opposite direction as the tightening direction to remove the shaft portion 106 from the fastener 160 of clamp 156.

Although the embodiments disclosed herein have been described in reference to pharmaceutical and food manufacturing industries, torque-limiting nuts 100, 200, 300 are not limited to such industries, and may be used for various applications and purposes including household plumbing, automotive manufacturing, and the like.

Furthermore, although the embodiments disclosed herein have been described with reference to particular features, it is to be understood that these features are merely illustrative of the principles and applications of the present disclosure. It is therefore to be understood that numerous modifications, including changes in the sizes of the various features described herein, may be made to the illustrative embodiments and that other arrangements may be devised without departing from the spirit and scope of the present disclosure. In this regard, the present disclosure encompasses numerous additional features in addition to those specific features set forth in the paragraphs below. Moreover, the foregoing disclosure should be taken by way of illustration rather than by way of limitation as the present disclosure is defined in the examples of the numbered paragraphs, which describe features in accordance with various embodiments of the disclosure, set forth in the paragraphs below.

1. A torque-limiting fastener comprising:
a head portion extending from a first end to a second end and including a first lumen extending longitudinally therethrough;
a shaft portion extending from the second end of the head portion to a free end and including a second lumen in operative communication with the first lumen, the second lumen extending longitudinally through the shaft portion; and
a plurality of perforations disposed at intervals around a periphery of at least one of the head portion and the shaft portion, the plurality of perforations being proximate a transition region in between the head portion and the shaft portion,
wherein the transition region forms a frangible connection between the head portion and the shaft portion.

2. The fastener of claim 1, wherein the second lumen is threaded and has a smaller diameter than the first lumen.

3. The fastener of claim 1, wherein the head portion further comprises a hexagonal outer surface.

4. The fastener of claim 1, wherein the plurality of perforations includes at least twelve perforations, each perforation of the plurality of perforations being disposed at approximately equal intervals around a periphery of at least one of the head portion and the shaft portion.

5. The fastener of claim 1, wherein each perforation of the plurality of perforations extends into an elongate recess along a length of the head portion such that the plurality of perforations includes a plurality of elongate recesses, the plurality of elongate recesses defining respective valleys and peaks around a periphery of the first lumen.

6. The fastener of claim 1, wherein each perforation of the plurality of perforations includes a channel formed longitudinally through at least a portion of the head portion, the shaft portion, and the transition region.

7. The fastener of claim 6, wherein the channel is formed longitudinally through an entire length of the head portion from the first end to the second end.

8. The fastener of claim 6, wherein each perforation of the plurality of perforations is defined in part by a recess in an outer surface of the shaft portion.

9. The fastener of claim 1, wherein the fastener is made of nylon.

10. A fastener comprising:
a head portion with a first diameter;
a shaft portion extending from the head portion, the shaft portion having a second diameter less than the first diameter; and
a plurality of apertures, each aperture of the plurality of apertures extending from an outer surface of the fastener to a lumen of the fastener, the lumen extending through a longitudinal dimension of the fastener,
wherein each aperture of the plurality of apertures includes a first surface region in the head portion and a second surface region in the shaft portion.

11. The fastener of claim 10, wherein each aperture of the plurality of apertures has a first maximum cross-sectional dimension.

12. The fastener of claim 10, wherein each aperture of the plurality of apertures is equally spaced around a perimeter of the lumen.

13. The faster of claim 10, wherein the plurality of apertures define a shear plane extending through a transition region between the head portion and the shaft portion such that when a predetermined torque is applied to the fastener, the fastener breaks along the shear plane.

14. The fastener of claim 13, wherein the predetermined torque is in a range from approximately of 30 in-lbs to approximately 50 in-lbs.

15. A method of securing a connection between pipe ends, the method comprising:
threading a nut onto a threaded rod of a clamp holding together two pipe ends with a gasket disposed between the pipe ends; and
applying torque to a head portion of the nut so that a shaft portion of the nut presses against a body of the clamp, the torque being applied until the head portion shears off the shaft portion along a shear plane, the shearing of the head portion occurring when the applied torque reaches a predetermined torque,
wherein the nut includes an outer surface between ends of a longitudinal dimension of the nut and the nut includes a longitudinally extending lumen, a portion of the outer surface being in operative communication with the longitudinally extending lumen to define the shear plane of the nut.

16. The method of claim 15, wherein the applying torque step further includes applying torque to the head portion such that the head portion shears along the shear plane defined by a plurality of perforations extending at least partially through at least one of the head portion of the nut and the shaft portion of the nut such that the head portion shears off the shaft portion simultaneously through each perforation of the plurality of perforations.

17. The method of claim 15, wherein the applying torque step further includes applying torque to the head portion such that the head portion shears along the shear plane at an interface between the head portion and the shaft portion.

18. The method of claim 15, wherein applying torque involves applying the predetermined torque where the predetermined torque is in a range from approximately 30 in-lbs to 50 in-lbs.

19. The method of claim 15, further comprising advancing the rod through an aperture of the clamp prior to threading the threaded lumen of the nut onto the rod.

20. The method of claim 15. further comprising, prior to the threading step. positioning a clamp around a first end region of a first pipe and a second end region of a second pipe when a gasket is disposed between the first end region and the second end region.
